(19) United States
(12) Patent Application Publication
(10) Pub. No.: US 2020/0102246 A1
(43) Pub. Date: Apr. 2, 2020

(54) CELLULOSIC PULP INTERNAL CURING AGENT FOR A HYDRAULIC CEMENT-BASED COMPOSITE MATERIAL

(71) Applicant: CANFOR PULP LTD., Burnaby (CA)

(72) Inventors: Paul Alexandre Bicho, Coquitlam (CA); Paul Andrew Watson, Rotorua (NZ); Nemkumar Banthia, Vancouver (CA); Obinna Onuaguluchi, Vancouver (CA)

(21) Appl. No.: 16/615,584

(22) PCT Filed: Jun. 5, 2017
(86) PCT No.: PCT/CA2017/000142

§ 371 Date: Nov. 21, 2019

(51) Int. Cl. C04B 24/38; C04B 20/02

(52) U.S. Cl. CPC C04B 24/383; C04B 2103/46; C04B 20/026

(57) ABSTRACT

A process for preparing a cellulosic pulp for use as an internal curing agent for a hydraulic cement-based composite material is disclosed. The process involves selecting a degree of refining of the cellulosic pulp to cause sufficient fibrillation to provide a change in water retention capacity for the cellulosic pulp while simultaneously limiting a decrease in dispersability within a mixture for forming the composite material due to excess fibrillation. The process also involves controlling refining of the cellulosic pulp using the selected degree of refinement to produce the cellulosic pulp internal curing agent.

### BACKGROUND

### 1. Field

This disclosure relates generally to cement based materials and more particularly to an internal curing agent for a hydraulic cement-based composite material.

### 2. Description of Related Art

Cement-based composites may be formed from mixtures including water pre-saturated internal curing agents such as lightweight aggregates and superabsorbent polymers (SAP). These curing agents are used to enhance hydration of cement-based materials and/or minimize self-desiccation. There remains a need for readily available materials for use as internal curing agents.

### SUMMARY

In accordance with one disclosed aspect there is provided a process for preparing a cellulosic pulp for use as an internal curing agent for a hydraulic cement-based composite material. The process involves selecting a degree of refining of the cellulosic pulp to cause sufficient fibrillation to provide a change in water retention capacity for the cellulosic pulp while simultaneously limiting a decrease in dispersability within a mixture for forming the composite material due to excess fibrillation. The process also involves controlling refining of the cellulosic pulp using the selected degree of refinement to produce the cellulosic pulp internal curing agent.

Controlling refining the cellulosic pulp may involve subjecting the cellulosic pulp to a controlled mechanical refining process.

Subjecting the cellulosic pulp to a mechanical refining process may involve processing the cellulosic pulp using one of a disk refiner, a conical refiner, a Hollander beater, homogenizer, and a Valley beater.

Selecting the degree of refining may involve establishing a degree of refining above which increased refining provides no substantive improvement in assessed characteristics of at least one of the mixture and the resulting composite material.

The degree of refining may be characterized in terms of an energy delivered during refining of the cellulosic pulp.

The assessed characteristics may include at least one of rheology of the mixture including the internal curing agent, autogenous deformation of the composite material during curing, porosity of the composite material when cured, uniformity of dispersion of the refined pulp within the mixture, uniformity of dispersion of the refined pulp within the composite material when cured, and a compressive strength of the composite material when cured.

Selecting the degree of refining may involve selecting the degree of refining to cause sufficient fibrillation to provide an increased water retention capacity of the cellulosic pulp.

In accordance with another disclosed aspect there is provided an internal curing agent for use in a hydraulic cement-based composite material made in accordance with the process above.

In accordance with another disclosed aspect there is provided an internal curing agent for use in a hydraulic cement-based composite material. The internal curing agent includes a cellulosic pulp refined to a degree of refining selected to cause sufficient fibrillation to provide a change in water retention capacity for the cellulosic pulp while simultaneously limiting a decrease in dispersability within a mixture for forming the composite material due to excess fibrillation.

The internal curing agent may be packaged for use in a water saturated surface dry condition.

In accordance with another disclosed aspect there is provided a cement-based mixture for a hydraulic cement-based composite material including a hydraulic cement-based portion, a water portion, and an internal curing agent portion. The internal curing agent portion includes a cellulosic pulp refined to a degree of refining selected to cause sufficient fibrillation to provide a change in water retention capacity for the cellulosic pulp while simultaneously limiting a decrease in dispersability within a mixture for forming the composite due to excess fibrillation.

The internal curing agent portion may include between about 0.5% and about 1% of the mixture by mass.

Other aspects and features will become apparent to those ordinarily skilled in the art upon review of the following description of specific disclosed embodiments in conjunction with the accompanying figures.

### BRIEF DESCRIPTION OF THE DRAWINGS

In drawings which illustrate disclosed embodiments,

FIG. 1 is a process flowchart of a process for preparing a cellulosic pulp for use as an internal curing agent in accordance with one disclosed embodiment;

FIG. 2A-2D are a series of schematic diagrams representing curing of a cement paste mixture including the internal curing agent produced by the process shown in FIG. 1;

FIG. 3 is a prior art depiction of a conventionally cured composite matrix;

FIG. 4 is a process flowchart of an embodiment for implementing a portion of the process shown in FIG. 1;

FIG. 5 is a graphical depiction of an average water retention values with specific refining energy for three different softwood kraft pulps;

FIGS. 6A and 6B are graphical depictions of results of water desorption tests performed on samples including the internal curing agent;

FIG. 7 is a graphical depiction of yield stress results for a cement paste mixture including the internal curing agent;

FIG. 8 is a graphical depiction of autogenous deformation results for samples including the internal curing agent;

FIG. 9 is a graphical depiction of Ca(OH)₂ content for samples including the internal curing agent;

FIG. 10 is a graphical depiction of porosity of for samples including the internal curing agent; and

FIG. 11 is a graphical depiction of compressive strength of samples including the internal curing agent.

### DETAILED DESCRIPTION

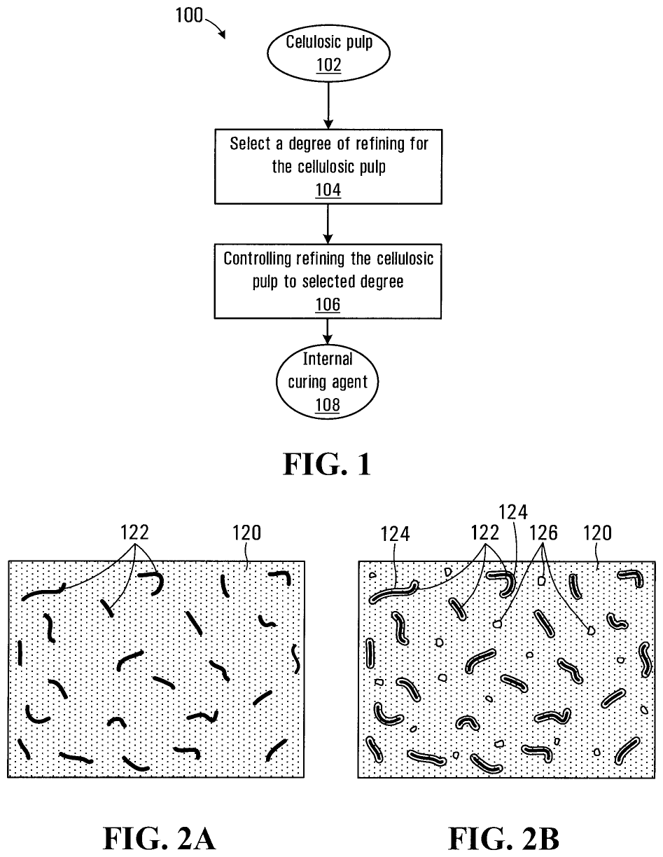

Referring to FIG. 1 a process for preparing a cellulosic pulp for use as an internal curing agent in a hydraulic cement-based composite material is shown as a process flowchart generally at 100. A cellulosic pulp 102 is prepared from a raw material such as wood, fiber, a crop, or recycled waste paper and generally involves chemically or mechanically separating cellulose fibers from lignin and hemicellulose. In one embodiment the cellulosic pulp 102 is a commercially processed bleached softwood pulp produced in a kraft process, but in other embodiment's different raw materials may be used and a different process may be used for preparing the cellulosic pulp.

At block 104 of the process 100 a degree of refining of the cellulosic pulp 102 is selected. The selection of the degree of refining is made to cause sufficient fibrillation of the cellulosic pulp to provide a change in water retention capacity for the cellulosic pulp. Refining generally causes physical changes to a cellulosic pulp, such as the degree of fiber refinement, which influences the physical morphology of fiber's water retention-desorption mechanisms.

At block 106, following selection of the degree of refining at block 104, the cellulosic pulp 102 is subjected to a controlled refinement to the selected degree to produce a refined cellulosic pulp internal curing agent 108. In one embodiment the refining may involve subjecting the cellulosic pulp to a controlled mechanical refining process, such as processing the pulp using a disk refiner, a conical refiner, a Hollander beater, homogenizer, a Valley beater, or other mechanical refining technique. In one embodiment the degree of refining selected at block 104 may be characterized in terms of a target energy to be delivered during refining of the cellulosic pulp, in which case an energy delivered to the pulp during the mechanical refining process may be controlled to deliver the target energy to the pulp. The refined cellulosic pulp 108 is produced as an output to the process 100 and may be used as an internal curing agent additive for curing hydraulic cement-based composite materials.

Hydraulic cement-based composite materials are typically formed from a mixture of aggregate, cement, water, and other additives. There is a need to adequately hydrate the mixture for optimal curing of the composite. If there is inadequate hydration of the mixture at any time over a period of several days after mixing, the resulting composite may have any of a number of flaws, such as autogenous deformation, porosity, and/or poor compressive strength. The refined cellulosic pulp internal curing agent 108 may be added to address mixture hydration.

The degree of refining of the cellulosic pulp 102 at block 104 may be selected to change a water retention capacity of the refined pulp, which in a cement-based mixture desorbs over time to provide hydration of the mixture while curing. The selection at block 104 is however further based on simultaneously limiting a decrease in dispersability within a mixture for forming the cement-based composite. If a specific degree of refinement results in excessive fibrillation of the cellulosic pulp, adding the internal curing agent 108 may adversely impact the workability of the mixture and inadequate dispersal of the cellulosic pulp within the mixture may result. Poor dispersal causes clumping of the refined cellulosic pulp, which following desorption may result in a cured composite having large pores that compromise properties of the resulting composite material.

Advantageously, the selection of the degree of refining as described above in connection with block 104 results in both sufficient water retention in the fibers of the cellulosic pulp and homogeneous dispersal of the internal curing agent thereby ensuring that entrained water within the cellulosic fibers is readily and uniformly available for hydrating cement particles within a matrix of the mixture.

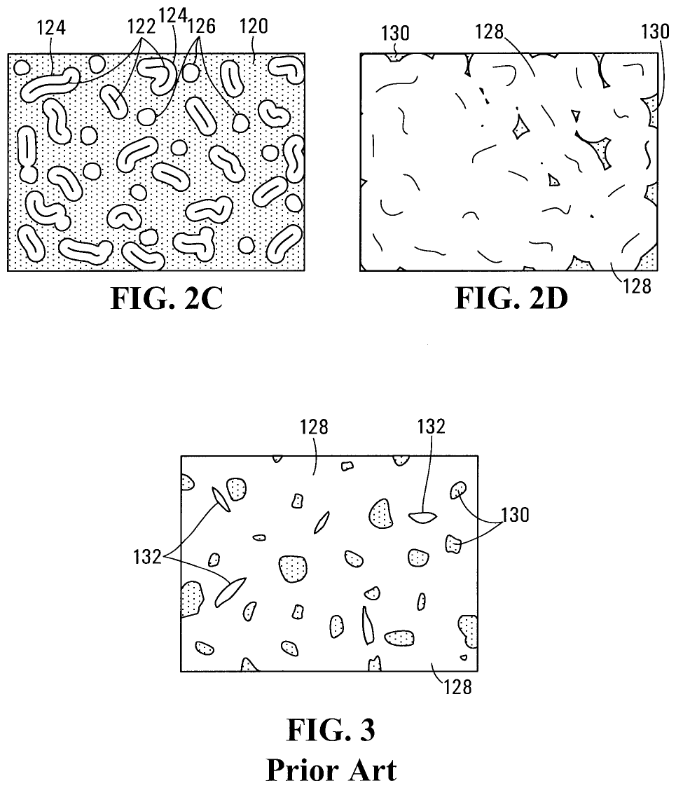

A series of schematic diagrams representing curing of a cement paste mixture over time are shown in FIG. 2. In FIG. 2A, a cement paste mixture 120 including hydraulic cement and water has been mixed together with fibers 122 of the refined cellulosic pulp internal curing agent 108. While practical composite mixtures usually include aggregate, this has been omitted in FIG. 2 for sake of illustration. The cellulosic fibers 122 of the refined cellulosic pulp internal curing agent 108 in the mixture have been previously fully saturated with water. FIG. 2B shows the same mixture some time later after the fibers 122 have begun to desorb, which provides additional hydration to the surrounding cement paste mixture 120. Partially cured composite regions 124 have begun to surround the fibers 122. At the same time, other partially cured composite regions 126 may also begin to form within the cement paste mixture 120 as curing progresses.

Referring to FIG. 2C, the composite regions 124 and 126 continue to develop over time as the curing progresses and while the cement paste mixture 120 is still adequately hydrated. In FIG. 2C, the fibers 122 have partially desorbed their originally entrained water and have begun to shrink.

Referring to FIG. 2D, at some time the cured composite regions 124 and 124 begin to merge and join forming cured composite matrix regions 128. At this time, some regions 130 remain that have not yet been adequately hydrated to fully cure. The regions 130 may remain within the cured composite matrix 128 as regions of uncured powdered cement mixture. Full curing of the cement paste mixture 120 may take from between several days to several weeks, depending on the temperature, level of external hydration, and other environmental conditions. A composite may be only considered to be fully cured after several months when it reaches full rated compressive strength.

Referring to FIG. 3, the cured composite result shown in FIG. 2D may be contrasted against a conventionally cured composite (depicted in FIG. 3) that does not include the cellulosic fibers. The cured composite in FIG. 3 has significantly more regions 130 that are improperly cured, thus potentially weakening the cured composite matrix 128 and forming cracks 132.

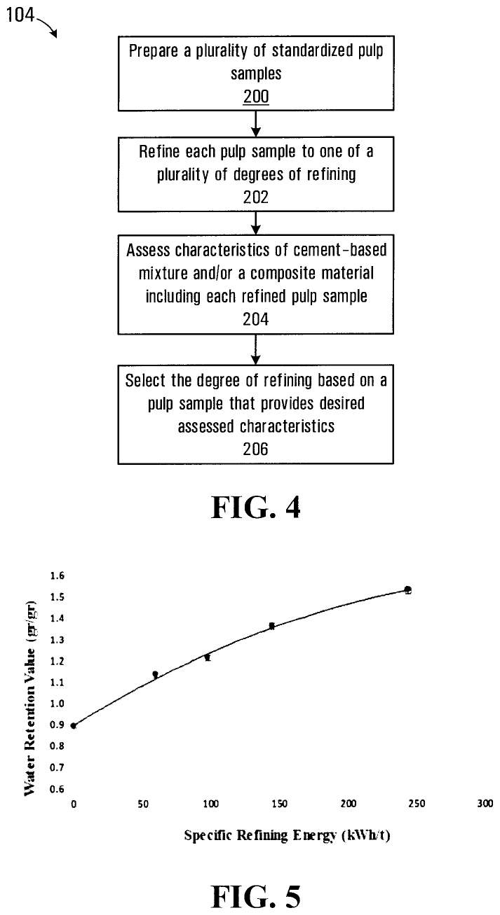

A process flowchart for implementing block 104 of the process 100 shown in FIG. 1 in accordance with one embodiment is shown in greater detail in FIG. 4. Referring to FIG. 4, at block 200 a plurality of standardized pulp samples are prepared. In general the pulp samples prepared at block 200 should be of uniform constitution and size. At block 202 each of the pulp samples is refined to one of a plurality of degrees of refining. For example, in embodiments where the degree of refining is characterized by an amount of energy delivered during refining of the cellulosic pulp, the degrees of refining may be at a plurality of energy levels applicable to a refining apparatus used.

At block 204 characteristics are assessed for each mixture including each refined pulp sample and/or for the resulting composite material. The assessed characteristics may include at rheology of the mixture, autogenous deformation of the composite material during curing, porosity of the composite material when cured, uniformity of dispersion of the refined pulp within the mixture and/or within the composite when cured, and a compressive strength of the composite when cured. Other characteristics that are considered important for any specific application may also be assessed.

At block 206, a selection is made of one of the pulp samples that based on a desired set of assessed characteristics. The desired characteristics may differ depending on the application. For example, in some applications compressive strength may be an overriding consideration, while in other applications other characteristics such as workability of the cement-base mixture may be of greater importance. In some instances, the assessed characteristics may show improvement to some level of refinement energy, following which there may be either no further improvement or there may be deterioration in the assessed characteristics for greater levels of refining energy.

Selecting the degree of refining may thus involve establishing a degree of refining above which increased refining provides no substantive improvement in assessed characteristics of the mixture and/or the resulting composite material.

### EXAMPLE

The assessment of characteristics at block 204 is described further by way of example. Commercially processed bleached softwood kraft pulp samples were refined in a Valley beater at energy levels of 100 KWh/t (referenced herein as “Ref+100”) and 185 KWh/t (“Ref+185”), respectively. An unrefined sample (“Ref+0”) was also reserved. The pulp samples were then vacuum de-watered and stored at 4° C. for reuse in the tests as described below. Prior to utilization for each test, a portion of each pulp sample was immersed in water for 24 hours and then centrifuged to saturated surface dry condition in accordance to the specifications of the Technical Association of the Pulp and Paper Industry (TAPPI) Useful Method (UM) 256.

### Fiber Physical Morphology

An assessment of the physical morphology of the fibers was performed using a high resolution fiber quality analyzer resulting in an average fiber length of 2.38 mm for the Ref+0 pulp sample, 2.24 mm for the Ref+100 pulp sample, and 2.15 mm for the Ref+185 pulp sample. The length distribution of fibers in each sample thus gradually decreased for increasing refinement energy. The reduction in fiber length is believed to be as a result of mechanical beating, which shears and damages the cell wall of fibers exposing an internal structure of the fibers to further fibrillation.

### Water Retention and Desorption

The water retention value (WRV) of each of the pulp samples was determined according to the specification of the TAPPI UM 256. Wet pulp samples were immersed in distilled water for 24 h and fiber pads obtained by vacuum filtration of the pulp suspensions, which were then centrifuged at 900 g for 30 min. The WRV of each sample was then calculated from the formula:

$$WRV = \frac{{M}_{w} - {M}_{d}}{{M}_{d}} \times 100$$

where M_{w} and M_{d} are wet mass after centrifugation and oven-dried mass, respectively. The WRV of the Ref+0 pulp sample was about 105%, the Ref+100 pulp sample about 165% and the Ref+185 pulp sample about 192%. Increased refinement energy thus provided significantly increased water retention in the cellulosic pulp samples.

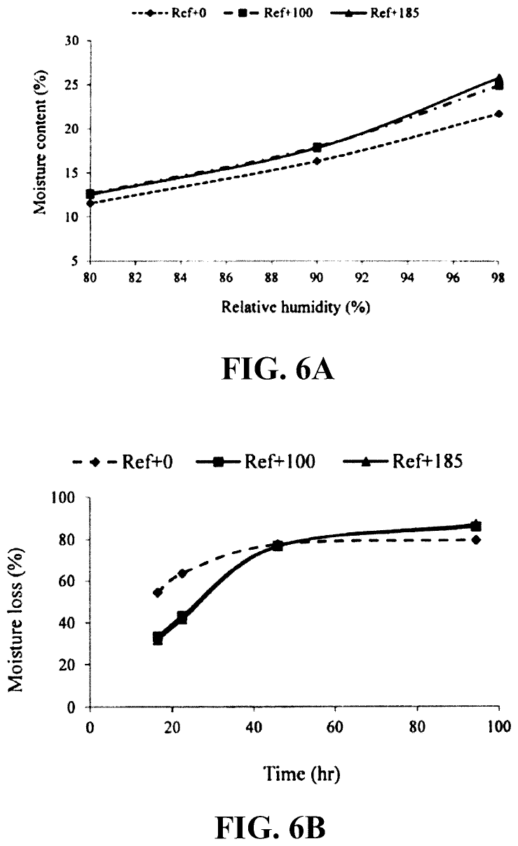

Referring to FIG. 5 average water retention values (gram of water per gram of pulp) for three different bleached softwood kraft pulps after being subjected to different levels of specific refining energy (kWh/t) are shown. Each value plotted in FIG. 6 is an average for the three different pulps. FIG. 6 shows that the above increase in WRV for the Ref+0, Ref+100, Ref+185 pulps also holds for different types of kraft pulp.

### Water Desorption

Saturated surface dry pads for each pulp sample were prepared according to TAPPI UM 256 Test Method. The samples were placed in an environmental chamber to equilibrate at 23° C. and 98% relative humidity (RH) until a constant mass was achieved. The equilibrium mass was recorded and the mass equilibrating process repeated from relative humidity of 97 to 50% RH. The samples were then oven dried until reaching a constant mass at 105° C. The percentage moisture content at each level of RH was then calculated using the following equation:

$$Moisture Content = \frac{{M}_{e} - {M}_{d}}{{M}_{d}} \times 100 ;$$

where Mₑ and M_{d} were the equilibrium masses at each specific relative humidity and oven-dried mass, respectively.

A significant release of moisture between 100% RH and 98% RH was observed for all of the pulp samples. However, while the refined Ref+100 and Ref+185 pulp samples had higher residual moisture compared to the Ref+0 pulp sample, over a range of relative humidity between 80% and 98% there was only a small difference in moisture content between the refined pulp samples. The results are shown graphically in FIG. 6A and FIG. 6B. Referring to FIG. 6A, a WRV normalized graph of moisture content as a function of relative humidity over the relative humidity range 80% RH to 98% RH shows generally similar moisture content for the refined Ref+100 and Ref+185 pulp samples. The Ref+0 sample had lower moisture content. Referring to FIG. 6B, a graph of normalized time-dependent moisture loss at 98% relative humidity shows that the un-refined Ref+0 pulp sample loses moisture more rapidly in the early hours of the test while the refined pulp samples Ref+100 and Ref+185 took longer to equilibrate. The graph of FIG. 6B also shows that there is little difference in the desorption behavior between the Ref+100 and Ref+185 pulp samples. The desorption results thus support a conclusion that while refining a pulp using moderate refinement energy provides a slower rate of moisture release, higher degrees of refinement (i.e. at 185 KWH/t) may provide no further hydration benefit in curing a cement-based mixture.

### Cement Paste Mixture Properties

Cement paste mixtures having a water-to-cement ratio of 0.35 and cellulosic pulp fractions between 0% and 1.0% by volume were prepared. Pre-saturated and surface dry cellulose pulp fibers were first dispersed in water with the aid of a mechanical stirrer followed by addition of cement. The cement paste mixture was mixed in a Hobart mixer for 2.5 minutes. A reference mixture having no cellulosic pulp was also prepared.

Rheological measurements were performed using a Haake Viscotester 550 with an attached four-bladed vane measuring 18 mm wide and 28 mm long. A cylindrical cup containing paste was approximately 40×60 mm in dimension and the rheological measurements were taken approximately 5 minutes after mixing operation commenced. Flow curves were produced by recording shear stress versus time data as the vane is slowly rotated at 0.2 s⁻¹ for 2 minutes and a maximum stress at which flow is initiated in each cement paste mixture was determined.

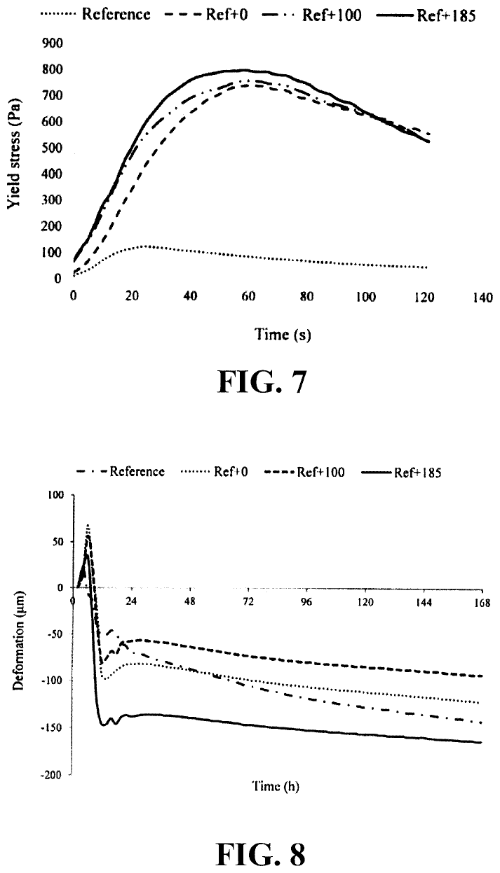

The yield stress of the cement paste mixtures is shown graphically in FIG. 7. Addition of cellulose fibers in the mixtures including Ref+0, Ref+100 and Ref+185 pulp samples increased the yield stress by a factor of 6.0 to 6.5 over the reference mixture. The extent of the rheological change when adding fiber was surprising. Cellulose fibers have a hydrophilic nature, which is enhanced by increased surface area of fibers resulting from refinement thus inducing changes mixture rheology. The change was most pronounced for the mixtures including the Ref+185 pulp samples, which may result in significantly reduced consistency of the mixture.

### Mortar Mixture Properties

Mortar mixtures also having a water-to-cement ratio of 0.35 and cellulosic pulp fractions between 0% and 1.0% by volume were prepared. Pre-saturated and surface dry cellulose pulp fibers were first dispersed in mix water with the aid of a mechanical stirrer followed by addition of cement, and a fine aggregate having a specific gravity of 2.65. A polycarboxylate-based superplasticizer was added at a 0.4% to 0.9% mass proportion to the cement to keep the consistency of mortar mixtures similar. The mortar mixture was mixed in a Hobart mixer for 6 minutes. A reference mixture having no cellulosic pulp was also prepared.

Autogenous deformation refers to the self-created deformation of a cement paste or mortar mix while curing to form a composite material. Mixture samples were cast in molds having dimensions 100×100×350 mm that were used to evaluate autogenous deformation of the prepared mortar mixtures. The inside surface of the molds were covered with Teflon sheets in order to reduce the frictional resistance between the sample and the molds. Prior to casting, a strain gauge was embedded horizontally at the mid-center of each mold and polyester sheets were used to seal the cast samples to reduce moisture evaporation. Thereafter, the cast samples were placed in an environmental chamber at 23° C. and 60% relative humidity and strain gauge data logging was initiated. After 24 hours, the cast samples were de-molded, sealed with an aluminum adhesive tape and returned to the environmental chamber. Strain measurements were zeroed at an initial set time of mixtures according to Japanese Concrete Institute (JCI, 1999) specifications.

Results are shown in FIG. 8 as a graph of deformation (i.e. strain as measured by the strain gauge) over time. All samples exhibited early expansion and there was significant shrinkage of the cellulose fiber reinforced samples in the first 10 hours. There was also shrinkage relaxation and variation in the post 24 hour timeframe for all samples. The significant increase in shrinkage of the mixtures containing cellulose fibers over the reference mixture that was observed in the early hours of the test is attributed to moisture sorption by the cellulosic fibers. Autogenous shrinkage was highest in the mixture including the Ref+185 pulp samples in the first 10 hours showing the greatest degree of sorption for this sample.

The shrinkage strain relaxation observed in the mixtures that included cellulosic pulp fiber is likely traceable to an improvement in the internal relative humidity induced by moisture desorption of the cellulosic fibers. However, while Ref+0 and Ref+100 mixtures showed a steep relaxation, the relaxation in the Ref+185 sample was smaller, which is probably as a result of the slower rate of desorption of the Ref+185 fibers in comparison to the other samples having less refined fibers. Although, slower desorption of the Ref+185 fibers ensured moisture availability and a lowest shrinkage rate of all samples after 24 hours, the effect of considerable deformation prior to 24 hours was not overcome. After 168 hours (i.e. 7 days) the average deformation for the mixtures were −143 μm for the reference, −122 μm for the Ref+0 mixture, −93.5 μm for the Ref+100 mixture and −164 μm for the Ref+185 mixture. The results indicate that while the sample including Ref+100 refined cellulosic pulp fibers reduced deformation by about 35% in comparison to the reference mixture, the Ref+185 fibers had the poorest performance, increasing deformation by about 15%. Notably the Reference mixture (i.e. having no cellulosic fiber additive) and the Ref+0 mixture both had a deformation that exceeded −100 μm, which is generally believed to be a threshold above which cracking occurs as shown in FIG. 3 at 132. The Ref+100 mixture was the only mixture that did not exceed −100 μm deformation, showing that selection of the degree of refining as described above has the advantage of limiting potential cracking in a cured composite material.

### Ca(OH)₂ Content

Ca(OH)₂ content in the cured composite is indicative of the degree of hydration of the mixture. Thermogravimetric analyses were conducted on the cured cement paste mixtures to evaluate the effect of the pre-saturated cellulosic pulp fibers on cement paste hydration after 28 days of moist curing. Cured cement paste samples were ground to a 75 μm particle size and were treated with methanol to stop cement hydration before being dried to constant mass at 105° C. For each cement paste mixture, samples weighing approximately 100 mg were heated from 30° C. to 950° C. at 10° C./min in a nitrogen atmosphere. Samples were subsequently held at 950° C. for 3 hours and subjected to a purge gas flow throughout the test duration of about 20 ml/min. Between temperatures of 400° C. and 500° C., an onset temperature, inflection, end temperature, and weight loss percentage were calculated using TGA Pyris software. Thereafter Ca(OH)₂ content for each sample was determined based on the stoichiometry of the Ca(OH)₂ dehydration reaction Ca(OH)₂→Ca0+H₂O.

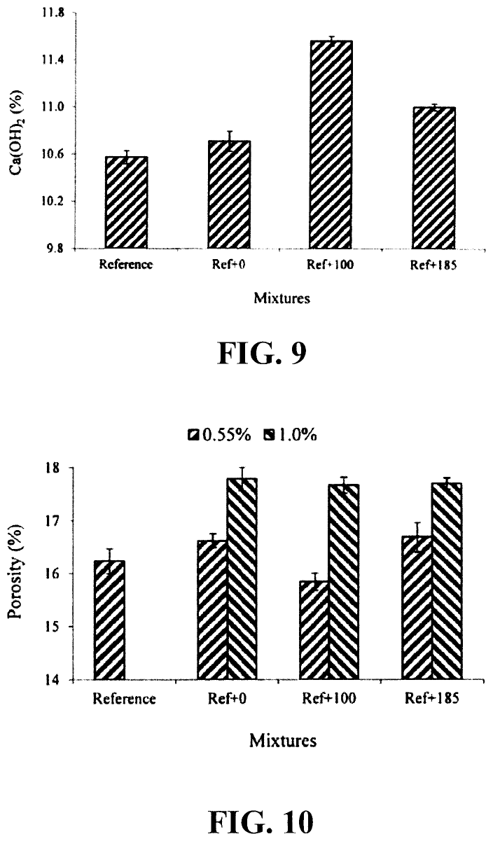

Ca(OH)₂ content results are shown graphically in FIG. 9 for the various cement paste mixtures showing that the Ref+100 sample had the greatest degree of hydration. Surprisingly, an expectation that mixtures including the Ref+185 cellulosic pulp fibers having the greatest retained water capacity value (WRV) would yield the highest hydration level in the cured cement paste mixture, was not realized. It is believed that this may be due to slower moisture release of the Ref+185 cellulosic fibers and/or poor dispersability of the fibers in the mixture due to excess fibrillation. Decreased permeability of the cement paste matrix at later curing age may restrict mobility of released water thus reducing internal curing efficiency. Furthermore poor dispersion and agglomeration of fibers may not only reduce the actual volume of fibers available for internal curing, but also increase the distance between fibers, thereby vitiating moisture availability for hydrating cement particles.

### Porosity and Compressive Strength

For each mixture, differences in the submerged, saturated and dry unit weights of 100 mm×50 mm cylindrical samples were used in determining the total permeable void content in accordance to ASTM C642 specifications. Furthermore, for each mixture, 50 mm cube samples were also used to determine the cube compressive strength at 3, 7 and 28 days. Test samples were placed in a compression test machine and loaded at a constant rate of 1.7 kN/s until failure occurred, as specified by ASTM C109 (2008).

Porosity results are shown graphically in FIG. 10 for samples having 0.55% and 1.0% cellulosic pulp content. With the exception of the cement paste mixture including 0.55% Ref+100 A fibers, the porosity of the mixtures containing refined cellulosic fiber were higher than those of the reference mixture, with significantly increased porosity of the 1.00% cellulosic pulp content mixtures. Increased porosity due to voids remaining after desorption of the fibers may thus at least partially outweigh the beneficial effect of enhanced hydration.

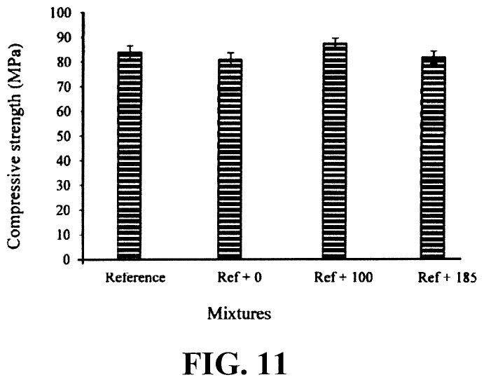

Compressive strength results are shown graphically in FIG. 11 for the 0.55% cellulosic pulp content samples after 28 days cure time. The greatest compressive strength improvement was about 12% relative to the reference mixture observed in mixtures containing 0.55% Ref+100 fibers after 28 days cure time. Notably, the Ref+185 sample had reduced compressive strength compared to the Ref+100 sample, indicating that the additional refining energy did not have a positive effect on compressive strength.

Based on the assessed characteristics of the samples in the above example, the Ref+100 sample refined at an energy of 100 KWh/t was found to provide improved overall characteristics with respect to the other samples. It was found that the Ref+185 sample refined at an energy of 180 KWh/t appeared to have been over-refined for the purposes of producing the refined cellulosic pulp internal curing agent 108.

In one embodiment, a refined cellulosic pulp may be produced in accordance with the process 100 and provided for use as an internal curing agent for hydraulic cement-based composites. The internal curing agent may be provided in a pre-saturated condition or may be fully saturated prior to use at the worksite where the mixture is prepared. The internal curing agent produced in accordance with the process 100 provides for adequate hydration of the mixture while reducing effects related to excess fibrillation.

While specific embodiments have been described and illustrated, such embodiments should be considered illustrative of the invention only and not as limiting the invention as construed in accordance with the accompanying claims.

1. A process for preparing a cellulosic pulp for use as an internal curing agent for a hydraulic cement-based composite material, the process comprising:
selecting a degree of refining of the cellulosic pulp to cause sufficient fibrillation to provide a change in water retention capacity for the cellulosic pulp while simultaneously limiting a decrease in dispersability within a mixture for forming the composite material due to excess fibrillation; and
controlling refining of the cellulosic pulp using the selected degree of refinement to produce the cellulosic pulp internal curing agent.

2. The process of claim 1 wherein controlling refining the cellulosic pulp comprises subjecting the cellulosic pulp to a controlled mechanical refining process.

3. The process of claim 2 wherein subjecting the cellulosic pulp to a mechanical refining process comprises processing the cellulosic pulp using one of:
a disk refiner;
a conical refiner;
a Hollander beater;
a homogenizer; and
a Valley beater.

4. The process of claim 1 wherein selecting the degree of refining comprises establishing a degree of refining above which increased refining provides no substantive improvement in assessed characteristics of at least one of the mixture and the resulting composite material.

5. The process of claim 4 wherein the degree of refining is characterized in terms of an energy delivered during refining of the cellulosic pulp.

6. The process of claim 4 wherein the assessed characteristics comprise at least one of:
rheology of the mixture including the internal curing agent;
autogenous deformation of the composite material during curing;
porosity of the composite material when cured;
uniformity of dispersion of the refined pulp within the mixture;
uniformity of dispersion of the refined pulp within the composite material when cured; and
a compressive strength of the composite material when cured.

7. The process of claim 1 wherein selecting the degree of refining comprises selecting the degree of refining to cause sufficient fibrillation to provide an increased water retention capacity of the cellulosic pulp.

8. An internal curing agent for use in a hydraulic cement-based composite material made in accordance with the process of claim 1.

9. An internal curing agent for use in a hydraulic cement-based composite material, the internal curing agent comprising:
a cellulosic pulp refined to a degree of refining selected to cause sufficient fibrillation to provide a change in water retention capacity for the cellulosic pulp while simultaneously limiting a decrease in dispersability within a mixture for forming the composite material due to excess fibrillation.

10. The internal curing agent of claim 9 packaged for use in a water saturated surface dry condition.

11. A cement-based mixture for a hydraulic cement-based composite material comprising:
a hydraulic cement-based portion;
a water portion; and
an internal curing agent portion comprising a cellulosic pulp refined to a degree of refining selected to cause sufficient fibrillation to provide a change in water retention capacity for the cellulosic pulp while simultaneously limiting a decrease in dispersability within a mixture for forming the composite due to excess fibrillation.

12. The cement-based mixture of claim 11 wherein internal curing agent portion comprises between about 0.5% and about 1% of the mixture by mass.

13. An internal curing agent for use in a hydraulic cement-based composite material made in accordance with the process of claim 2.

14. An internal curing agent for use in a hydraulic cement-based composite material made in accordance with the process of claim 3.

15. An internal curing agent for use in a hydraulic cement-based composite material made in accordance with the process of claim 4

16. An internal curing agent for use in a hydraulic cement-based composite material made in accordance with the process of claim 5.

17. An internal curing agent for use in a hydraulic cement-based composite material made in accordance with the process of claim 6.
